(19) United States
(12) Patent Application Publication
(10) Pub. No.: US 2014/0127426 A1
(43) Pub. Date: May 8, 2014

(54) multi-in-one decorative painting

(71) Applicant: Hangzhou Meisheng Classical Crafts Co., Ltd., Hangzhou (CN)

(72) Inventor: Yun Luo, Hangzhou (CN)

(21) Appl. No.: 13/940,243

(22) Filed: Jul. 11, 2013

(30) Foreign Application Priority Data
Nov. 7, 2012 (CN) 201210438762

(51) Int. Cl. B44D 3/18

(52) U.S. Cl. CPC B44D 3/18
USPC 428/14

(57) ABSTRACT

A multi-in-one decorative painting, consists of mother decorative painting, which is composed by the canvas and frame, the canvas is taken up to the frame, and evenly fixed connecting in the inwall of the frame with nails, the front of the canvas is the mother decorative painting, the back of the canvas and the frame is the multi-in-one area of the child decorative painting. The child one is smaller than the mother one, in usual, the number of child one can be from one to four, and there is an invisibility carry apparatus which is installed outside of the frame, it can achieve the effect of several different sizes inconsistent, but the overall style is same. It can meet the needs of matching use for customer, while increasing the effective use of raw materials.

### FIELD OF INVENTION

The invention relates to a decorative painting, in particular to combine some multiple decorative paintings into one. but without increasing of the footprint.

### BACKGROUND OF THE INVENTION

Decorative painting as a high-end home indoor or outdoor decorations, has been widely used in current society, it can be landscapes, characters or abstract art, etc., which is in harmony with the collocation of indoor or outdoor environment, with a more high artistic value, but also can add the whole aesthetic effect of the indoor or outdoor environment, so the decorative painting had become more and more popular. For the current decorative painting, it's a single one, when people give someone a gift or promotional use, it will be required a decorative painting which can contain some multiple but in same style together. as a gift, but they all can't solve the above problems.

### SUMMARY OF THE INVENTION

In order to solve the existing technical deficiencies, the invention provides an apparatus of a multi-in-one decorative painting, it can combine some multiple decorative paintings into one according to customers' different needs, without increasing of the footprint. The enterprises can combine some multiple but in same style decorative paintings into one as a gift box. The advantage of the apparatus is simple structure, but the practicality and overall aesthetic effect of the decorative painting is very good.

The technical proposal of the invention is that A multi-in-one decorative painting, consists of mother decorative painting. which is composed by the canvas and frame, the canvas is taken up to the frame, and evenly fixed connecting in the inwall of the frame with nails, the front of the canvas is the mother decorative painting. the back of the canvas and the frame is the multi-in-one area of the child decorative painting. The child one is smaller than the mother one, in usual, the number of child one can be from one to four, and there is an invisibility carry apparatus which is installed outside of the frame.

At the above structure of multi-in-one decorative painting, it can achieve the effect of several different sizes inconsistent, but the overall style is same. Easier for people to make better use after purchase, and for enterprises, they can process the child one by the waste of processing the mother one, in order to reduce the cost and waste of resources. The invention can combine two or more child decorative paintings into one according to customers' different needs, without increasing of the cost of transport and storage.

The beneficial effect can be provided after adopting this invention is that which can meet the needs of matching use for customer, while increasing the effective use of raw materials.

In order to better understand the characteristics and the technical described of the invention, please check the details from the following accompanying drawings and embodiments. But the attached embodiment is for reference and illustrative purposes only, not to limit the invention.

### BRIEF DESCRIPTION OF DRAWINGS

FIG. 1 is a front view of the invention;

FIG. 2 is a back view of the invention;

FIG. 3 shows the effect view of the invention;

FIG. 4 is the embodiment fig of two-in-one decorative painting;

FIG. 5 is the embodiment fig of three-in-one decorative painting;

FIG. 6 is the embodiment fig of four-in-one decorative painting;

FIG. 7 is the embodiment fig of five-in-one decorative painting;

In the picture: 1-canvas; 2-frame; 3-multi-in-one area of the child decorative painting; 4-nails; 5-child decorative painting; 6-invisibility carry apparatus.

### DETAILED DESCRIPTION OF THE INVENTION

By the following embodiments, introducing the detailed description of the invention:

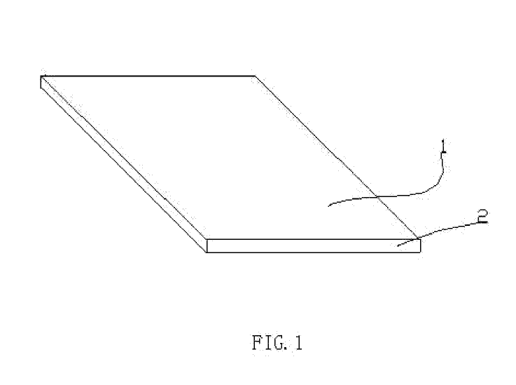

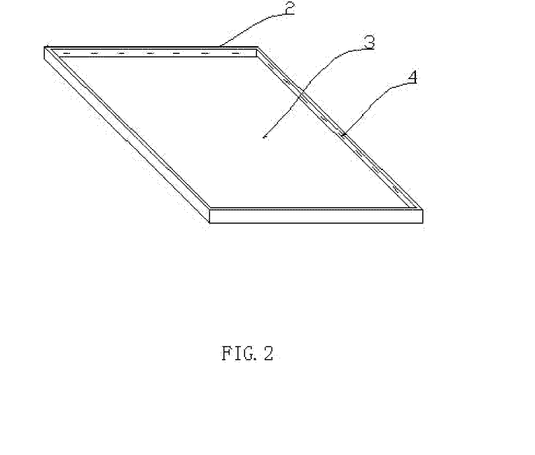

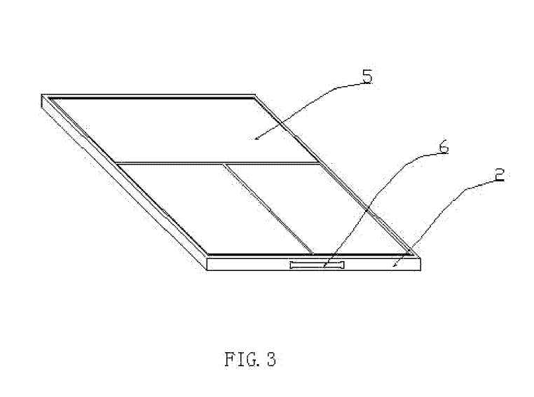

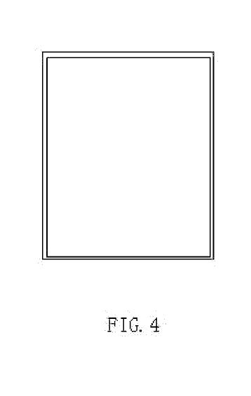

Embodiment 1: As shown on FIG. 1-4, the two-in-one decorative painting, consists of mother decorative painting, which is composed by the canvas (1) and frame (2), the canvas (1) is taken up to the frame (2), and evenly fixed connecting in the inwall of the frame (2) with nails (4), the front of the canvas (1) is the mother decorative painting, the back of the canvas (1) and the frame (2) is the multi-in-one area of the child decorative painting (3). The child one (5) is smaller than the mother one, in usual, there is one child one (5), and there is an invisibility carry apparatus (6) which is installed outside of the frame (2).

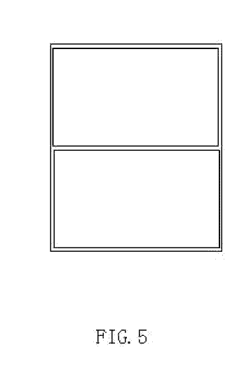

Embodiment 2: As shown on FIG. 1-3 and FIG. 5, the three-in-one decorative painting, consists of mother decorative painting, which is composed by the canvas (1) and frame (2), the canvas (1) is taken up to the frame (2), and evenly fixed connecting, in the inwall of the frame (2) with nails (4), the front of the canvas (1) is the mother decorative painting, the back of the canvas (1) and the frame (2) is the multi-in-one area of the child decorative painting (3). The child one (5) is smaller than the mother one, in usual, there are two child ones (5), and there is an invisibility carry apparatus (6) which is installed outside of the frame (2).

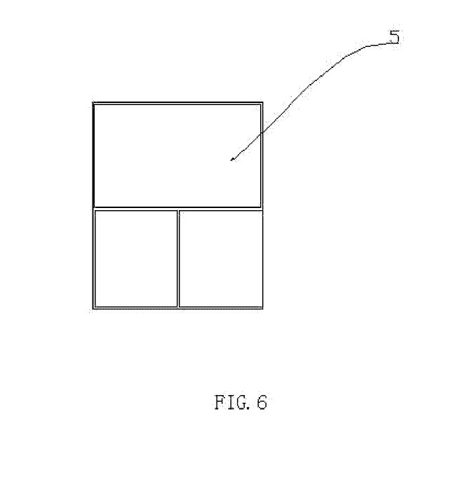

Embodiment 3: As shown on FIG. 1-3 and FIG. 6, the four-in-one decorative painting, consists of mother decorative painting, which is composed by the canvas (1) and frame (2), the canvas (1) is taken up to the frame (2), and evenly fixed connecting, in the inwall of the frame (2) with nails (4), the front of the canvas (1) is the mother decorative painting, the back of the canvas (1) and the frame (2) is the multi-in-one area of the child decorative painting (3). The child one (5) is smaller than the mother one, in usual, there are three child ones (5), and there is an invisibility carry apparatus (6) which is installed outside of the frame (2).

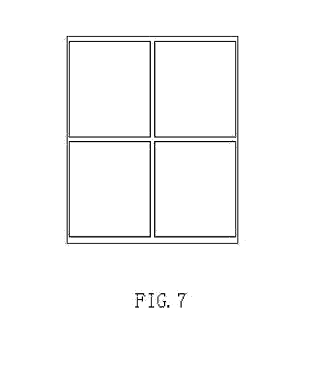

Embodiment 4: As shown on FIG. 1-3 and FIG. 7, the five-in-one decorative painting, consists of mother decorative painting, which is composed by the canvas (1) and frame (2), the canvas (1) is taken up to the frame (2), and evenly fixed connecting in the inwall of the frame (2) with nails (4), the front of the canvas (1) is the mother decorative painting, the back of the canvas (1) and the frame (2) is the multi-in-one area of the child decorative painting (3). The child one (5) is smaller than the mother one, in usual, there are four child ones (5), and there is an invisibility carry apparatus (6) which is installed outside of the frame (2).

At the above structure of multi-in-one decorative painting, it can achieve the effect of several different sizes inconsistent, but the overall style is same. Easier for people to make better use after purchase, and for enterprises, they can process the child one by the waste of processing the mother one, in order to reduce the cost and waste of resources. The invention can combine two or more child decorative paintings into one according to customers' different needs, without increasing of the cost of transport and storage.

While this invention has been described with reference to illustrative embodiments, these descriptions are not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

What is claimed is:

1. A multi-in-one decorative painting, characterized that it is consisted of mother decorative painting, which is composed by the canvas and frame, the canvas is taken up to the frame, and evenly fixed connecting in the inwall of the frame with nails, the front of the canvas is the mother decorative painting, the back of the canvas and the frame is the multi-in-one area of the child decorative painting. The child one is smaller than the mother one, in usual, the number of child one can be from one to four, and there is an invisibility carry apparatus which is installed outside of the frame.
